(19) United States
(12) Patent Application Publication
(10) Pub. No.: US 2010/0332736 A1
(43) Pub. Date: Dec. 30, 2010

(54) METHOD OF OPERATING NONVOLATILE MEMORY DEVICE

(76) Inventors: Kyu Hee LIM, Seoul (KR); Seong Je Park, Gyeonggi-do (KR)

Correspondence Address: IP & T GROUP LLP, 7700 Little River Turnpike, Suite 207, Annandale, VA, 22003, US

(21) Appl. No.: 12/764,520

(22) Filed: Apr. 21, 2010

(30) Foreign Application Priority Data
Jun. 29, 2009 (KR) 10-2009-0058449

(51) Int. Cl. G06F 12/00; G06F 12/02

(52) U.S. Cl. 711/103; 711/206; 711/E12.001; 711/E12.059

(57) ABSTRACT

A method of programming a nonvolatile memory device comprises storing first data of a first memory block in a page buffer unit, and then programming the first data into a redundant memory block coupled to the page buffer unit, storing second data of a second memory block in the page buffer unit, and then programming the second data into the first memory block, storing third data of a third memory block in the page buffer unit, and then programming the third data into the second memory block, storing the second data of the first memory block in the page buffer unit, and then programming the stored second data into the third memory block, and storing the first data stored in the redundant memory block in the page buffer unit, and then programming the stored first data into the first memory block.

### CROSS-REFERENCE TO RELATED APPLICATION

Priority to Korean patent application number 10-2009-0058449 filed on Jun. 29, 2009, the entire disclosure of which is incorporated by reference herein, is claimed.

### BACKGROUND

Exemplary embodiments relate to a method of operating a nonvolatile memory device and, more particularly, to the refresh operation of a nonvolatile memory device.

There is an increasing demand for nonvolatile memory devices which can be electrically programmed and erased and which do not require the refresh function of rewriting data at specific intervals. Herein, the term ‘program’ refers to an operation of writing data into a memory cell.

To increase the degree of integration of memory devices, a NAND type flash memory device has been developed where a plurality of memory cells are coupled together in series (the drain or the source is shared by neighboring memory cells), thus forming one string. The NAND type flash memory device, unlike a NOR type flash memory device, is a memory device configured to sequentially read information.

However, data stored in cells of NAND type flash memory devices may no longer be reliable after a certain time period. This reliability concern arises because electric charges stored in the floating gate of a flash memory cell are gradually lost after a certain time period. This certain time period in which data stored in the floating gates of a flash memory cell are reliable is called a retention period. In other words, data stored by NAND type flash memory devices can be lost after expiration of the retention period, which is determined by the characteristics of the flash memory cell.

### BRIEF SUMMARY

Exemplary embodiments relate to a refresh operation capable of improving the retention characteristic of a nonvolatile memory device by reprogramming data in a memory block in such a manner that data stored in a first memory block of memory blocks are read and programmed into a redundant memory block, and data stored in a second memory block of the memory blocks are read and programmed into the first memory block.

A method of programming a nonvolatile memory device according to an aspect of the present disclosure comprises reading first data of a first memory block, storing the first data in a page buffer unit, and then programming the first data into a redundant memory block coupled to the page buffer unit, reading second data of a second memory block, storing the second data in the page buffer unit, and then programming the second data into the first memory block, reading third data of a third memory block, storing the third data in the page buffer unit, and then programming the third data into the second memory block, reading the second data of the first memory block, storing the read second data in the page buffer unit, and then programming the stored second data into the third memory block, and reading the first data stored in the redundant memory block, storing the read first data in the page buffer unit, and then programming the stored first data into the first memory block.

A method of operating a nonvolatile memory device comprising first to N^{th} memory blocks according to another aspect of the present disclosure comprises reading data of the first memory block and programming the read data into a redundant memory block, reading data from the second memory block unit to the N^{th} memory block while increasing an address of each of the second memory block unit to the N^{th} memory block, and programming the read data into the first to (N−1)^{th} memory block, respectively, wherein N is a natural number, reading the data programmed into the first memory block and programming the read data into the N^{th} memory block, and reading the data programmed into the redundant memory block and programming the read data into the first memory block.

A method of operating a nonvolatile memory device, which comprises a plurality of memory blocks and a redundant memory block for temporarily storing data during a refresh operation, according to another aspect of the present disclosure comprises reading program data of a selected memory block of the plurality of memory blocks, storing the read program data in a page buffer unit, and programming the stored program data into the redundant memory block coupled to the page buffer unit, erasing the selected memory block, and reading the program data stored in the redundant memory block, storing the read program data in the page buffer unit, and programming the stored program data into the selected memory block.

### BRIEF DESCRIPTION OF THE DRAWINGS

FIG. 1 is a diagram illustrating the operation of a nonvolatile memory device according to a first embodiment of the present disclosure;

FIG. 2 is a flowchart illustrating the operation of the nonvolatile memory device according to the first embodiment of the present disclosure; and

FIG. 3 is a diagram illustrating the operation of a nonvolatile memory device according to a second embodiment of the present disclosure.

### DESCRIPTION OF EMBODIMENTS

Hereinafter, exemplary embodiments of the present disclosure will be described in detail with reference to the accompanying drawings. The figures are provided to allow those having ordinary skill in the art to understand the scope of the embodiments of the disclosure.

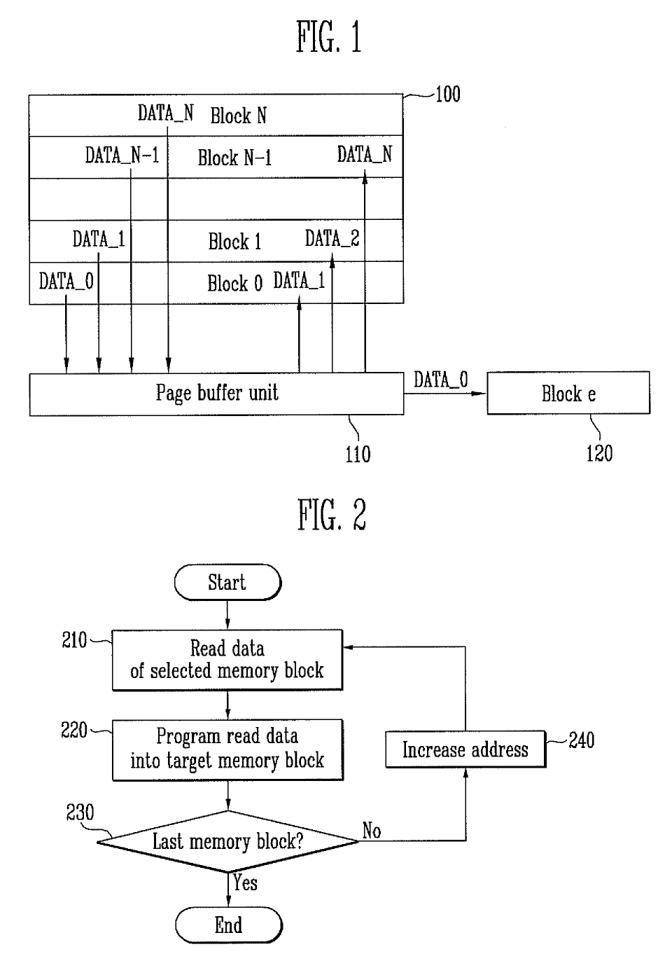

FIG. 1 is a diagram illustrating the operation of a nonvolatile memory device according to a first embodiment of the present disclosure.

Referring to FIG. 1, the nonvolatile memory device includes a memory block unit 100 configured to include a plurality of memory blocks Block 0 to Block N, a page buffer unit 110 coupled to the memory block unit 100, and a redundant memory block Block e 120 coupled to the page buffer unit 110.

FIG. 2 is a flowchart illustrating the operation of the nonvolatile memory device according to the first embodiment of the present disclosure.

A refresh operation of the nonvolatile memory device according to an embodiment of the present disclosure is described below with reference to FIGS. 1 and 2.

First, data (e.g., data DATA_0) of a first memory block (e.g., Block 0) of the memory block unit 100 are read and stored in the page buffer unit 110 at step 210. That is, the data DATA_0 stored in the selected memory block Block 0 are read.

Next, the data DATA_0 stored in the page buffer unit 110 are programmed into the redundant memory block Block e 120 at step 220. That is, the data DATA_0 are temporarily stored in the memory block Block e 120.

The steps 210 and 220 are described in more detail below. The data DATA_0 stored in the first memory block Block 0 are read and temporarily stored using a page buffer of the page buffer unit 110. Next, the data DATA_0 are programmed into the redundant memory block Block e 120 coupled to the page buffer. Here, since the memory block includes a plurality of pages, the data DATA_0 are moved from the memory block Block 0 to the redundant memory block Block e 120 by sequentially performing the read and program operations on a page basis.

Next, the first memory block Block 0 is erased by performing an erase operation.

It is then determined whether the read memory block is the last memory block (i.e., Block N) of the memory block unit 100 at step 230. If, as a result of the determination, the read memory block is determined not to be the last memory block Block N of the memory block unit 100, a block address of the corresponding memory block is increased by 1 at step 240. That is, a next memory block (i.e., Block 1) is selected.

Next, the process returns to step 210. In other words, data DATA_1 stored in the next memory block Block 1 are read and stored in the page buffer unit 110.

Next, the data DATA_1 stored in the page buffer unit 110 are programmed into the first memory block Block 0.

After the above read and program operations are repeatedly performed for each memory block, the data of the first memory block Block 0 are programmed into the redundant memory block Block e 120, the data of the second memory block Block 1 are programmed into the first memory block Block 0, and the data of the last memory block Block N are programmed into the memory block Block N−1.

Furthermore, in general, information about important data elements of the memory device may be stored in the first memory block Block 0. When the memory device is operated, the information about the important data elements is first selected and used. Accordingly, the data DATA_1 stored in the first memory block Block 0 may be moved to the last memory block Block N using the page buffer unit 110. Next, after the first memory block Block 0 is erased, the data DATA_0 programmed into the redundant memory block Block e 120 may be moved to the first memory block Block 0 using the page buffer unit 110.

As described above, the nonvolatile memory device can be refreshed by reprogramming data, stored in a plurality of the memory blocks Block 0 to Block N of the memory block unit 100, into the redundant memory block Block e 120 and a plurality of the memory blocks Block 0 to Block N−1. Accordingly, the retention characteristic of the nonvolatile memory device can be improved.

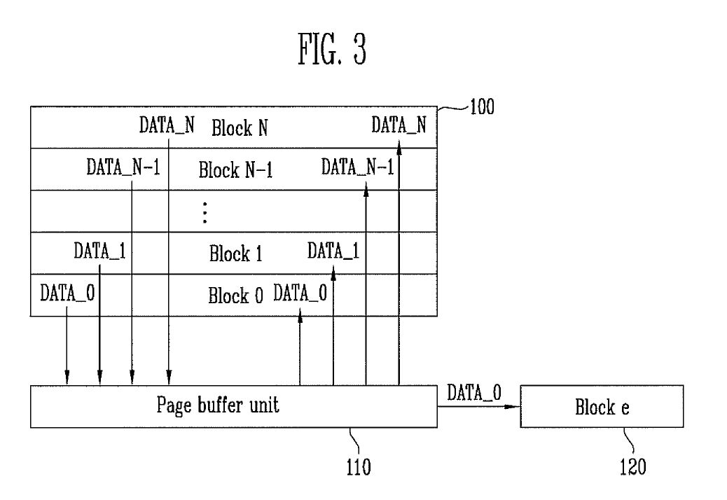

FIG. 3 is a diagram illustrating the operation of a nonvolatile memory device according to a second embodiment of the present disclosure.

Referring to FIG. 3, the nonvolatile memory device includes a memory block unit 100 configured to include a plurality of memory blocks Block 0 to Block N, a page buffer unit 110 coupled to the memory block unit 100, and a redundant memory block Block e (120) coupled to the page buffer unit 110.

The operation of the nonvolatile memory device according to the second embodiment of the present disclosure is described below with reference to FIG. 3.

First, data (e.g., data DATA_0) stored in a first memory block (e.g., Block 0) of the memory block unit 100 are read and stored in the page buffer unit 110. That is, the data DATA_0 of the selected memory block Block 0 are read.

Next, the data DATA_0 stored in the page buffer unit 110 are programmed into the redundant memory block Block e 120. That is, the data DATA_0 are temporarily stored in the memory block Block e 120.

Specifically, the data DATA_0 stored in the first memory block Block 0 are read and temporarily stored using a page buffer of the page buffer unit 110. The stored data DATA_0 are programmed into the redundant memory block Block e 120 coupled to the page buffer. Here, since the memory block includes a plurality of pages, the data DATA_0 are moved from the memory block Block 0 to the redundant memory block Block e 120 by sequentially performing the read and program operations on a page basis.

The first memory block Block 0 is then erased by performing an erase operation.

Next, the data DATA_0 temporarily stored in the redundant memory block Block e 120 are read and temporarily stored in the page buffer unit 110. The data DATA_0 stored in the page buffer unit 110 are then programmed into the first memory block Block 0.

Next, the redundant memory block Block e 120 is erased.

It is then determined whether the corresponding memory block (i.e., the selected memory block Block 0) is the last memory block (i.e., Block N) of the memory block unit 100. If, as a result of the determination, the selected memory block Block 0 is determined not to be the last memory block Block N of the memory block unit 100, a block address of the selected memory block Block 0 is increased by 1, and a next memory block (i.e., Block 1) is selected.

Next, as in the operation for the first memory block Block 0, data DATA_1 stored in the second memory block Block 1 are read and temporarily stored in the page buffer unit 110. The stored data DATA_1 are programmed into the erased first memory block Block 0. After the second memory block Block 1 is erased, the data DATA_0 stored in the redundant memory block Block e 120 are read and temporarily stored in the page buffer unit 110. The stored data DATA_0 are programmed into the erased second memory block Block 1.

If the above read and program operations are repeatedly performed by increasing the block address of a memory block, data stored in a plurality of the memory blocks Block 0 to Block N are temporarily stored in the redundant memory block Block e 120 and then programmed into the original memory blocks Block 0 to Block N again. As a result, a refresh operation is performed on the memory blocks Block 0 to Block N.

According to the present disclosure, data of a memory block are reprogrammed in such a manner that data of a first memory block of a plurality of memory blocks are programmed into a redundant memory block, and data of a second memory block of the memory blocks are read and programmed into the first memory block. Accordingly, a refresh operation capable of improving the retention characteristic of a nonvolatile memory device is provided.

What is claimed is:

1. A method of programming a nonvolatile memory device, the method comprising:
reading first data of a first memory block, storing the first data in a page buffer unit, and then programming the first data into a redundant memory block coupled to the page buffer unit;
reading second data of a second memory block, storing the second data in the page buffer unit, and then programming the second data into the first memory block;
reading third data of a third memory block, storing the third data in the page buffer unit, and then programming the third data into the second memory block;
reading the second data of the first memory block, storing the read second data in the page buffer unit, and then programming the stored second data into the third memory block; and
reading the first data stored in the redundant memory block, storing the read first data in the page buffer unit, and then programming the stored first data into the first memory block.

2. The method of claim 1, further comprising erasing the first memory block after programming the first data into the redundant memory block.

3. The method of claim 1, further comprising erasing the second memory block after programming the second data into the first memory block.

4. The method of claim 1, further comprising erasing the third memory block after programming the third data into the second memory block.

5. The method of claim 1, further comprising erasing the second memory block after programming the second data into the third memory block.

6. A method of operating a nonvolatile memory device comprising first to N^{th} memory blocks, the method comprising:
reading data of the first memory block and programming the read data into a redundant memory block;
reading data from the second memory block unit to the N^{th} memory block while increasing an address of each of the second memory block unit to the N^{th} memory block, and programming the read data into the first to (N−1)^{th} memory block, respectively, wherein N is a natural number;
reading the data programmed into the first memory block and programming the read data into the N^{th} memory block; and
reading the data programmed into the redundant memory block and programming the read data into the first memory block.

7. The method of claim 6, further erasing a memory block from which data have been read.

8. A method of operating a nonvolatile memory device, which comprises a plurality of memory blocks and a redundant memory block for temporarily storing data during a refresh operation, the method comprising:
reading program data of a selected memory block of the plurality of memory blocks, storing the read program data in a page buffer unit, and programming the stored program data into the redundant memory block coupled to the page buffer unit;
erasing the selected memory block; and
reading the program data stored in the redundant memory block, storing the read program data in the page buffer unit, and programming the stored program data into the selected memory block.

9. The method of claim 8, further comprising, after programming the stored program data into the selected memory block:
determining whether the selected memory block is a last memory block of the plurality of memory blocks;
if, as a result of the determination, the selected memory block is determined not to be the last memory block of the memory blocks, increasing an address of the selected memory block and setting a memory block corresponding to the increased address, from among the plurality of memory blocks, as a newly selected memory block;
reading data programmed into the newly selected memory block and programming the read data into the redundant memory block;
erasing the newly selected memory block; and
reading the data programmed into the redundant memory block, storing the read data into the page buffer unit, and programming the stored data into the newly selected memory block.
